(19) United States
(12) Patent Application Publication
(10) Pub. No.: US 2006/0294123 A1
(43) Pub. Date: Dec. 28, 2006

(54) Database systems and processes for storage and retrieval of electronic and related documents

(75) Inventor: Gerald Altman, Auburndale, MA (US)

Correspondence Address: MEYERTONS, HOOD, KIVLIN, KOWERT & GOETZEL, P.C., 700 LAVACA, SUITE 800, AUSTIN, TX, 78701, US

(73) Assignee: New Grounds LLC

(21) Appl. No.: 11/513,847

(22) Filed: Aug. 31, 2006

Related U.S. Application Data
(63) Continuation of application No. 10/667,401, filed on Sep. 23, 2003.
Application No. 10/667,401 is a continuation-in-part of application No. 09/665,188, filed on Sep. 17, 2000, now Pat. No. 6,775,422.
Application No. 09/665,188 is a continuation-in-part of application No. 08/882,833, filed on Jun. 26, 1997, now Pat. No. 6,236,767.
(60) Provisional application No. 60/020,902, filed on Jun. 27, 1996.

(51) Int. Cl. G06F 7/00

(52) U.S. Cl. 707/100

(57) ABSTRACT

A computer system and process involves entry into a RAID storage array of a digital computer system, at a succession of date/time instances, a succession of records of electronic documents, some of which may have corresponding physical originals, assignment of attributes to the records in any data-type formats that characterize the documents, assignment of a succession of unique date/time identifiers to the succession of records in correspondence with the date/time instances of their entry, selection of a range of date/time instances that correspond to a range of the records of documents that are known to be uncorrupted, and selection of groups of electronic documents having logically related attributes within the range of the uncorrupted documents.

### CROSS-REFERENCES TO RELATED APPLICATIONS

The present application is a continuation-in-part of co-pending application Ser. No. 09/665,188, filed on Sep. 17, 2000 in the name of Gerald Altman for Systems, Processes, and Products for Storage and Retrieval of Physical Paper Documents, Electro-optically Generated Electronic Documents, and Computer Generated Electronic Documents, which is a continuation-in-part of earlier co-pending application Ser. No. 08/882,833, filed on Jun. 26, 1997 in the name of Gerald Altman for System and Method for Storing and Retrieving Matched Paper Documents and Electronic Images, now U.S. Pat. No. 6,236,767, dated May 22, 2001, which in turn is based upon the disclosure and claims the filing date of provisional Application No. 60/020,902, filed on Jun. 27, 1996 in the name of Gerald Altman for Matched Electronic And Paper Documents In An Integrated Storage And Retrieval System.

### STATEMENT REGARDING FEDERALLY SPONSORED RESEARCH OR DEVELOPMENT

Not Applicable

### BACKGROUND OF THE INVENTION

1. Field of the Invention

The present invention relates to database systems and processes utilizing date/time addressing for security in the storage and retrieval of electronic and related documents.

2. Description of the Related Art

Numerous systems and processes have been proposed for the storage and retrieval of documentary information. Now, there have been both a proliferation of traditional paper storage and a massive migration to electronic storage. Both require greater security. The storage and retrieval of physical documents suffer from widespread problems in manual indexing and physical inaccessibility. The storage and retrieval of electronic documents suffer from vulnerability to hardware malfunction, software corruption and human error. Information now is so critically essential to enterprise survival that data resources, both electronic and physical, require new approaches to information security.

Much confusion has occurred in implementing systems that are based on: (1) imaged electronic documents of the type that are created by scanning or photographing paper documents and the like, (2) original paper documents themselves, and (3) computer generated electronic documents of the type that are created by all manner of transactions such as, word processing and graphics programs, e-mail and facsimile transmissions, and the like.

The present invention is based on recognition that there is a need for a document-centric relational database, which: (1) optimizes the inherent inefficiency of physical documents and the inherent efficiency of electronic documents; (2) intelligibly and intuitively facilitates the interactions between these documents and any database in which they are contained; and (3) provides security for all documents, both electronic and physical, which may be mishandled, misplaced or corrupted.

### SUMMARY OF THE INVENTION

The object of the present invention is to improve the security of systems and processes for the storage and retrieval of electronic and physical documents. The present invention uses date/time addressing for storing and accessing both electronic and physical documents, and facilitating their interaction.

A more specific object of the present invention is to provide a computer system and process involving (1) entry into a storage array, at a succession of date/time instances, a succession of records of electronic documents, some of which may have corresponding physical originals, (2) assignment of attributes to the records in any data-type formats that characterize the documents, (3) assignment of a succession of unique date/time identifiers to the succession of records in correspondence with the date/time instances of their entry, (4) selection of a range of date/time instances that correspond to a to a range of the records of documents that are known to be uncorrupted, and (5) selection of groups of electronic documents having logically related attributes within the range of the uncorrupted documents.

The arrangement is such that the date/time succession of unique identifiers facilitates (1) recovery of electronic records even if hardware or software malfunction or corruption has occurred, and (2) retrieval of hard-to-find physical documents if they have been visually marked and simply stacked in accordance with the date/time instances of their records. The present invention is applicable to electronic and physical entries, either separately or combined.

A still more specific object of the present invention is to provide a relational database comprising a structure of tables and forms having the following features: a CODE table and form containing records of Persons & Organizations; a FILE table and form containing records of File Numbers & Physical Locations; a CASE table and form containing job records in the syntax cccccffffff, which corresponds to a junction of the CODE and FILE entries; a PLAN table and form containing records of Events, Tasks and Dates; and a VIEW table and form containing records and views of documents.

### BRIEF DESCRIPTION OF THE DRAWINGS

For a fuller understanding of the nature and objects of the present invention, reference is made to the following specification, which is to be taken in connection with the accompanying drawings wherein:

FIG. 1 illustrates an electronic and physical system for processing input streams of electronic and physical documents pursuant to the present invention;

FIG. 2 illustrates a graphical user interface for presentation and control of a database according to the present invention;

FIG. 3 illustrates a graphical user interface for restoring corrupted data on the basis of date/time ranges of records pursuant to the present invention;

FIG. 4 illustrates a graphical user interface for selecting uncorrupted data on the basis of date/time ranges of records pursuant to the present invention;

FIG. 5 is a flow diagram illustrating details of a well known RAID hard disk array that is particularly adapted for storage of date/time addressed records pursuant to the present invention;

FIG. 5 is a flow diagram of a process for controlling the RAID array of FIG. 4;

FIG. 6 is a MAP of the forms of the relational data base illustrated herein as embodying aspects of the present invention;

FIG. 7 shows the CODE form of the diagram of FIG. 6;

FIG. 8 shows the FILE form of the diagram of FIG. 6;

FIG. 9 shows the CASE form of the diagram of FIG. 6;

FIG. 10 shows the PLAN form of the diagram of FIG. 6;

FIG. 11 shows the VIEW form of the diagram of FIG. 6; and

FIG. 12 shows the steps of an implementation of the process of the present invention.

### DETAILED DESCRIPTION OF THE PREFERRED EMBODIMENTS

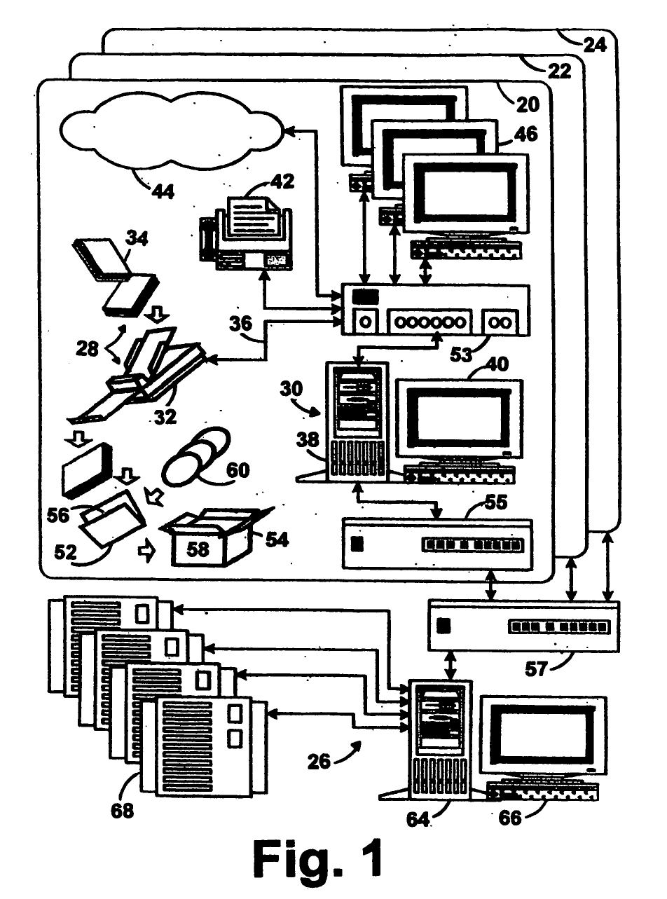

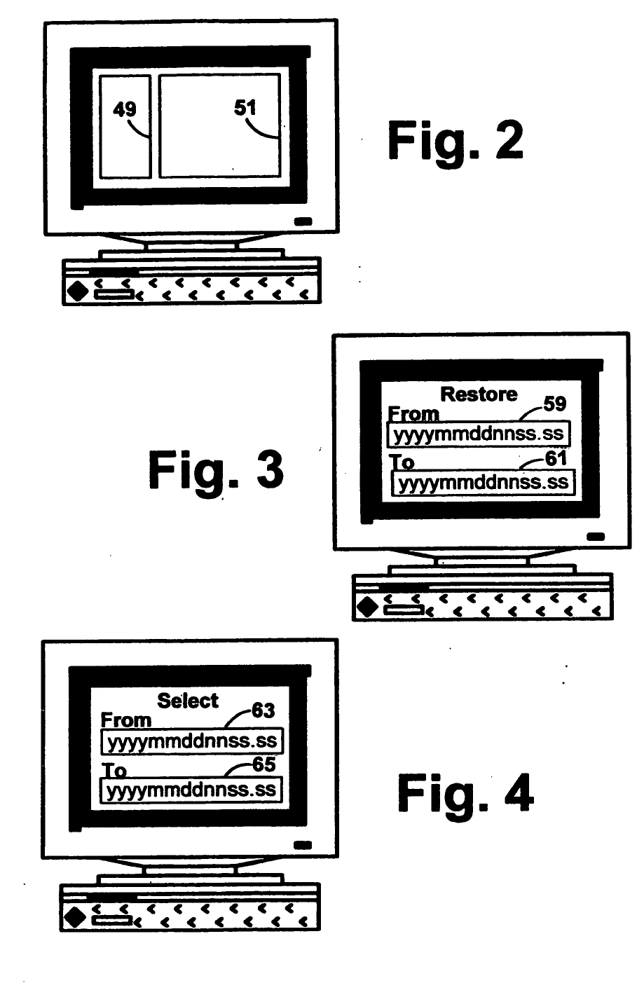

### The Physical and Electronic Systems of FIGS. 1 and 2

As shown in FIG. 1, the illustrated embodiment of the present invention comprises a cluster of distributed systems 20, 22, 24 and a master system 26, all at different physical locations.

Each of the distributed systems includes a physical system 28 and an electronic system 30. These systems share a scanner 32. Scanner 32 processes random sequences of physical paper documents 34 to produce sequences of electronic documents at 36, which are received by a local server 38 under the control of a work station 40. A fax machine 42, an internet connection 44, and a cluster of work stations 46 also produce sequences of electronic documents that are received by local server 38. Work stations 46 are connected to the remainder of the system by a hub 53.

Each work station 40 includes a graphical user interface, a keyboard, and a mouse (not shown). As shown in FIG. 2, the graphical user interface may present a control window 49 and a view window 51, side-by-side. As shown in FIG. 3, the graphical user interface may present a control window by which a range, shown at 59 and 61, of entries in the electronic storage system may be restored. And, as shown in FIG. 4, the graphical user interface may present a control window by which any range, shown at 63 and 65, of entries in the electronic storage system may be selected.

As will be explained in detail below, the CODE, FILE, CASE, PLAN and VIEW tables and forms of the present invention provide a document-centric, electronic and physical database, which enables (1) random entry into the database of physical documents and other media, (2) precision entry into the database of such corresponding electronic images and other data as may be appropriate, and (3) precise indicia of where physical documents, other physical media, and electronic data are stored for retrieval whenever required.

As shown in FIG. 1, the batches of physical paper documents 34, after being scanned, are collected for physical storage in folders or pockets 52, which, in turn, are filed in boxes or other repositories 54. Folders 52 are visually marked as at 56 and boxes 54 are visually marked as at 58 with indicia that indicate the ranges of date/time instances of the successions of records with which documents 34 are associated in the electronic system. Local server 38 is operatively connected to scanner 32 for transmission of control signals to the scanner, and receipt from the scanner of data signals representing electronic documents and their unique date/time identifiers.

Workstation 40 enables the entry by an operator of commands that: (1) direct scanner 32 to selectively produce images of paper documents 34 and direct local server 38 to receive date/time addressed records of the storage of these images, (2) direct local server to receive date/time addressed records of the entry of other physical media, such as floppy disks, CDs, DVDs, and tapes, shown at 60, which may be physically stored in files 52 and repositories 54, and (3) direct the generation of electronic documents that include fax documents from fax machine 42, e-mail documents from link 44, and work documents from work stations 46.

In one configuration of the system of FIG. 1, the various physical media are directed along different scheduling tracks to different physical repositories as follows.

A first track directs physical documents 34 into appropriate file folders or file pockets 52, and then directs the file folders or pockets into appropriate filing repositories 54. In one version, the physical documents and media are indexed and stored alphabetically in conventional file folders or pockets, which in turn are indexed and arranged alphabetically. These file folders are collected in containers, which also are indexed and arranged alphabetically. Here, the file folders or file pockets and the containers in which they are collected are visually marked with alphabetic indicia. The result is a file of alphabetically indexed and stored sets of physical documents, the precise locations of which are recorded electronically. Conventional physical storage of this type are accommodated by the illustrated system and may be desirable in the case of extremely important documents, although it usually requires close and time consuming attention.

In another track, the physical documents are indexed and stored in numerical order in conventional file folders or pockets, which, in turn are indexed and arranged numerically. These file folders are collected in containers, which also are indexed and arranged alphabetically. Here, the file folders or file pockets and the containers in which they are collected are physically marked with numerical indicia. The result is a file of numerically indexed and stored sets of physical documents, the precise locations of which are recorded electronically. Universal numerical physical storage of this type may be desirable in various circumstances, although it usually requires reference to records that are not self explanatory.

In the preferred track, the physical documents are indexed and stored in the file folders or pockets in the date/time sequence of their date/time instances of scanning. These file folders are collected in containers, which also are indexed and arranged in the order of their date/time instances of scanning. Here, the file folders or file pockets and the containers in which they are collected are physically marked with ranges of date/time instances. The file folders or pockets, in turn, are indexed and arranged in their date/time instances of becoming filled. The result is a file of date/time indexed and stored sets of physical documents, the precise locations of which are recorded electronically. The advantages of this track are fully explained in U.S. Pat. No. 6,236,767, issued May 22, 221, U.S. Pat. No. 6,396,964, issued May 28, 2002, and U.S. Pat. No. 6,456,747, issued Sep. 24, 2002, both of which are incorporated herein by reference.

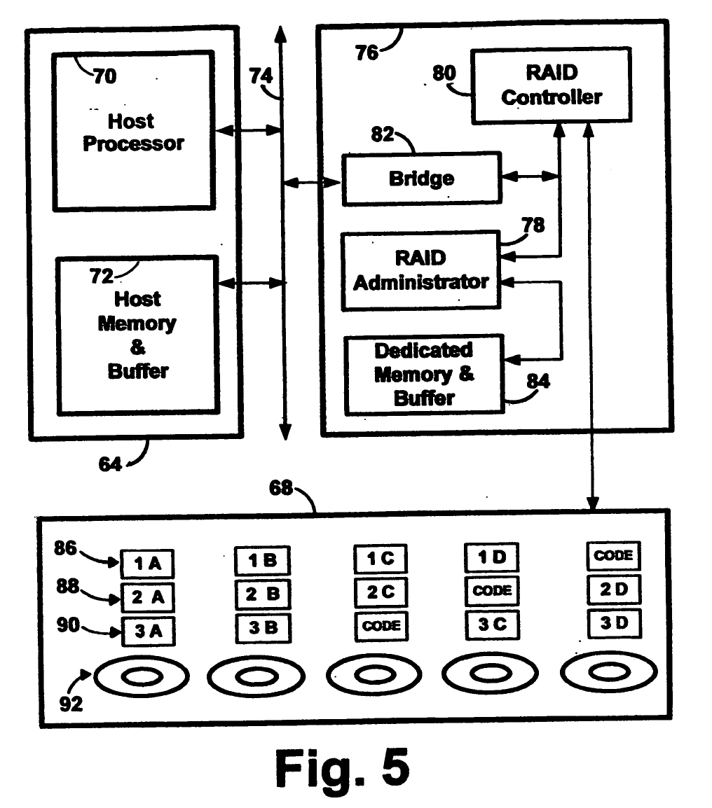

### The RAID Storage System of FIGS. 1 and 5

The illustrated data storage system includes a redundant array of independent (or inexpensive) disks of the type generally known as a RAID system. As shown in FIG. 1, the storage system includes a host server 64 and a plurality of hard disk arrays 68. The host server is connected to distributed systems 20, 22 and 24 by distributed bridges 55 and a host bridge 57.

As shown in FIG. 5, data is distributed over plural disk drives to enable parallel operation, which improves access and provide fault tolerance. As is well known, a RAID system typically achieves parallelism by some combination of mirroring, striping and parity. While the present system implements a RAID 5 configuration, it is to be understood that all RAID configurations can be implemented in accordance with the present invention.

The present RAID 5 system provides parallelism by striping data blocks among N disks and provides fault tolerance by using a 1/N relationship for storing parity blocks. These parity blocks are calculated by combining the exclusive-OR (XOR) results of all data blocks in the parity disks. A RAID system of the general type utilized herein is detailed in U.S. Pat. No. 6,526,477, dated Feb. 25, 2003, in the names of Joe J. Yuan, et al, for Host-memory Based RAID System, Device, and Method, which has been assigned to Adaptec, Inc. of Milpitas, Calif. This patent, particularly a prior art system that is referenced in this patent, is incorporated hereinto by reference. This prior art system does not include or reference the date/time addressable storage of the present invention.

The RAID system of FIG. 4 herein shows relationships among host server 64, a main bus 74, an adaptor 76, and RAID array 68. Host server 64 includes a host processor 70 and a host memory and buffer 72, which are operatively connected to main bus 74. Adaptor 76 includes a RAID administrator unit 78 and a RAID controller unit 80, which are operatively connected to bus 74 by a bridge 82. A dedicated memory and buffer 84 is connected to RAID administrator unit 78.

The three rows of data shown in disk array 68 show how data 86, 88 and 90 are striped across all five disks 92.

The RAID sequence of operations is as follows. RAID administrator 78 receives new main data from host memory 72 and stores the new main data in dedicated memory 84. Next, old main data and old parity data, which are residing in the disk array, are accessed and copied into dedicated memory 84. Next, RAID administrator unit 78 accesses this data to perform the XOR operation and to generate new parity data. The new main data and new parity data then are stored in disk array 68.

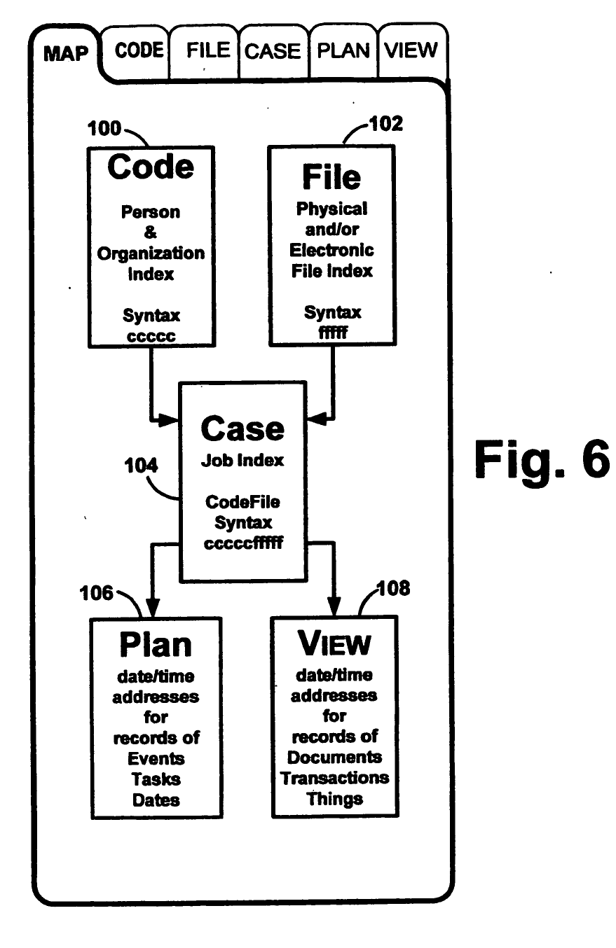

### The Relational Database of FIGS. 6 to 11

The database specifically illustrated herein is based on building blocks provided in software sold by Microsoft Corporation, of Seattle, Wash., U.S.A., under the trademark Microsoft Access (the Access Building Blocks). The present invention is the result of a novel combination of selections from and interrelationships among the Access Building Blocks, as well as other structures and relationships.

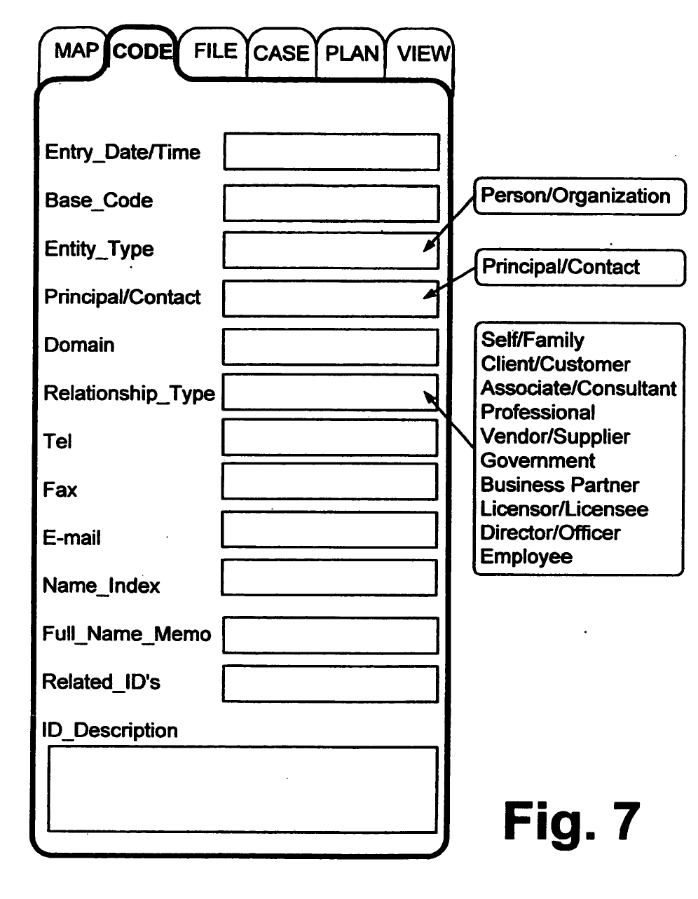

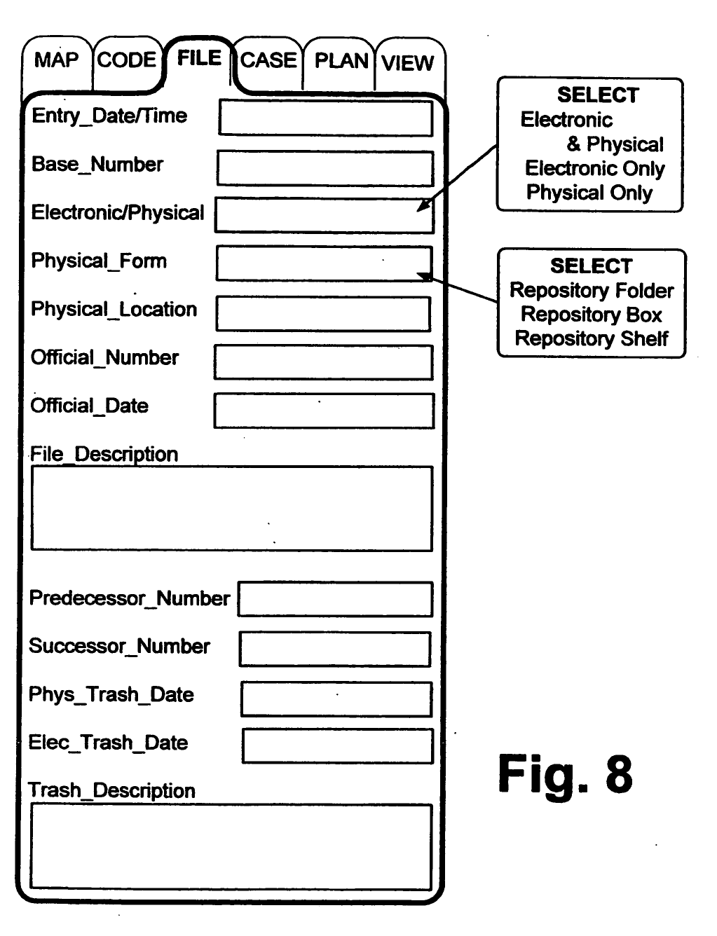

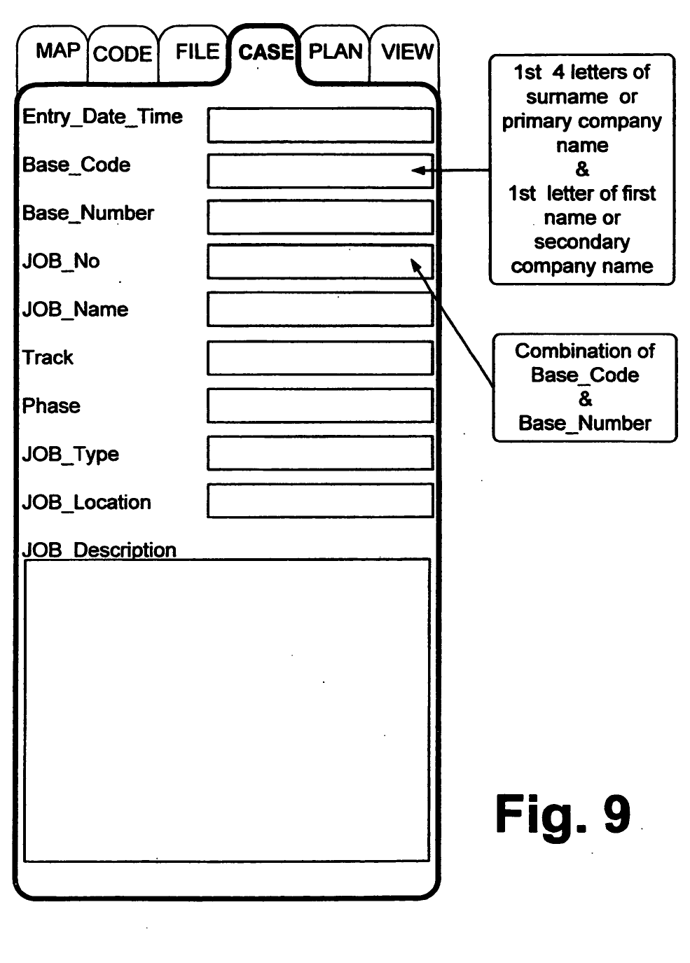

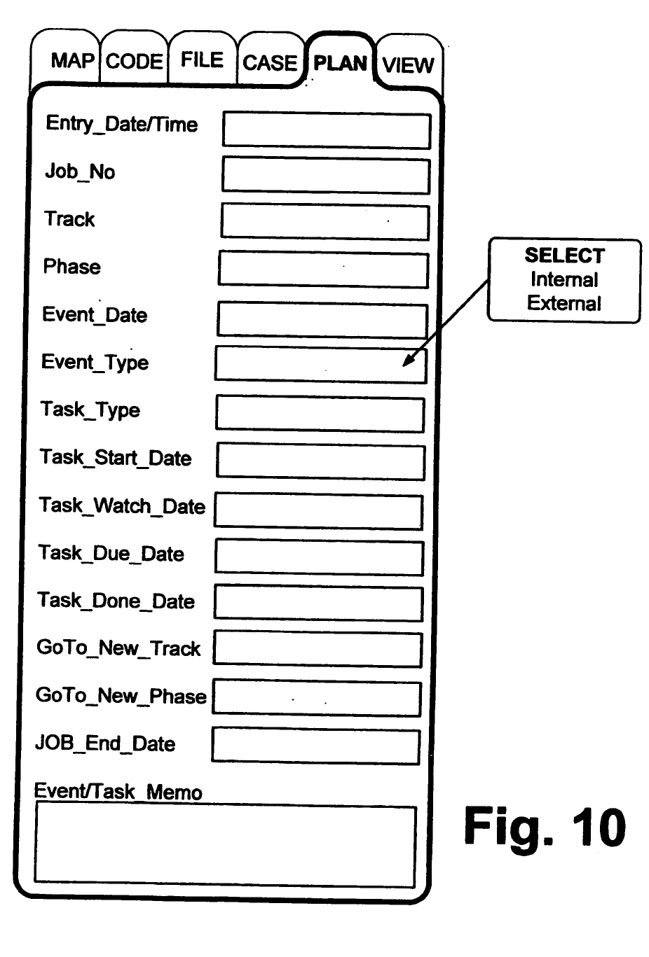

A map of tables of the illustrated database and blow-ups of the database components depicted therein are shown in FIGS. 6 to 11 as they appear tabbed in the control window 49 of any of work stations 40, 46 and 66. These forms are based upon tables that include a CODE table 100, a FILE table 102, a CASE table 104, a PLAN table 106, and a VIEW table 108. The CODE table contains records of persons & organizations as is shown in the form of FIG. 7. The FILE table contains records of file numbers and physical file locations as is shown in the form of FIG. 8. The CASE table contains combination records in the format (syntax), cccccffffff, which corresponds to a junction of key entries in the CODE and FILE tables as shown in the form of FIG. 9. The PLAN table contains records of events, tasks and dates as shown in the form of FIG. 10. The VIEW table contains records and views of physical documents, including things other than paper documents, as shown in the form of FIG. 10.

FIG. 7 shows the CODE form, which includes a unique Base_Code field as its key. This CODE field identifies each entity in the database by a unique code. A preferred code, which is not novel per se, comprises as values either of the following. (1) In the case of an organization, the code consists of the first five alphanumeric characters of a company name plus a successive integer beginning with 001. (2) In the case of an individual, the code consists of the first five alphanumeric characters of the individuals surname plus a successive integer beginning with 001. The successive integer serves to distinguish codes of companies and individuals that are otherwise the same.

FIG. 8 shows the FILE form, which includes a unique Base_Number field as its key. This number is a unique identifier that identifies each file. The FILE form also has an Official_No field, which, for example, may refer to a government agency Serial Number or Registration Number, a court docket number, a medical plan or group number, an insurance policy number, a retail or wholesale customer number, a law practice client number, a medical practice patient number, or the like. As set forth above, physical documents of different entities, which may be classified in any such File_No or Official_No field, are randomly dispersed throughout the primary and secondary repositories of physical system 30.

FIG. 9 shows the CASE form which includes a unique Job_No as its key. This Job_No is a construct which includes a combination of the Base_Code of the CODE table and the Base_Number of the FILE table.

FIG. 10 shows the PLAN form, which records events, resulting tasks, and their various dates, all in connection with any entry in the CASE form.

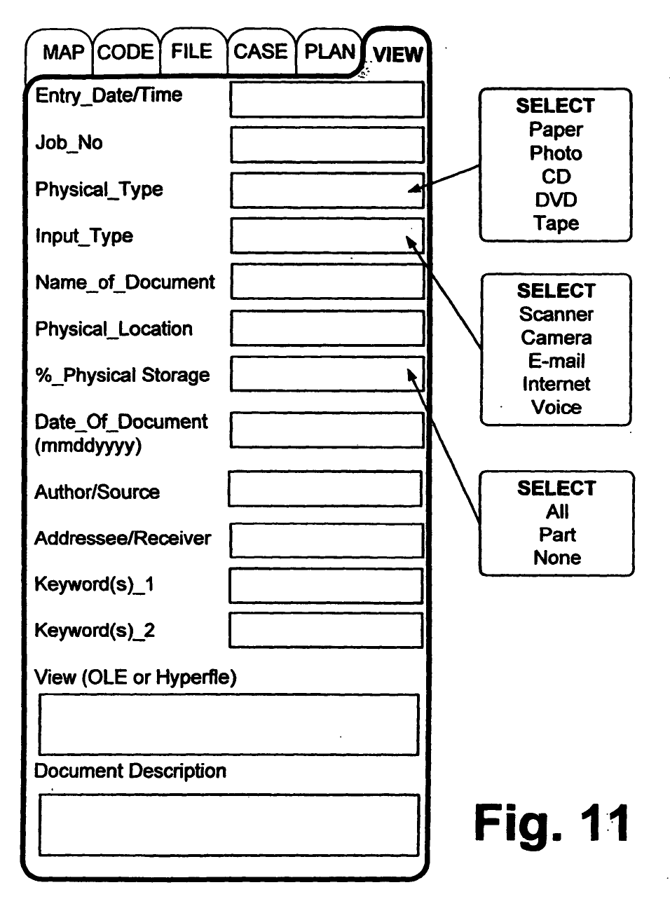

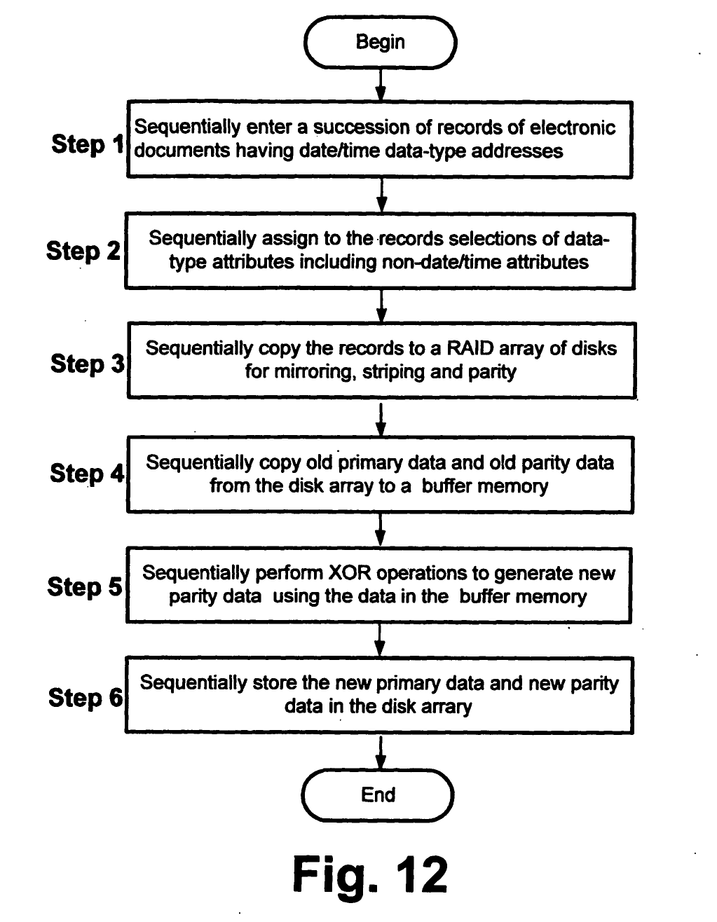

FIG. 11 shows the VIEW form, which includes a Entry_Date/Time field. This field contains Date/Time values that uniquely identify the electro-optical or computer-generated presentations, i.e. values, in the VIEW field. Preferably, a unique value in the Entry_Date/Time field is generated automatically by the system during scanning or computer generation, preferably in terms of year, month, day, hour, minute, second and fraction of second (yy, mm, dd, hh, nn, ss, ff). Thus each electro-optically generated document or computer-generated document is uniquely identified at the moment of its entry by a date/time address or pointer. The data type of the VIEW field is any electronic document, i.e. data object, that is supported by the electronic system, whether image, text, vector or bit map.

The illustrated relational database includes the following relational links among its tables. The Base_Code of the CODE table is linked to the Base_Code fields of the VIEW table and the CASE table. The File_No field of the FILE table is linked to the File_No fields of the VIEW table and the CASE table. The arrangement is such that: (1) the specific location of any properly marked physical document is immediately known, no matter who the person is who manually filed the physical document; and (2) the database is, in effect, its own backup because of the immediacy by which specific electronic entries can be assembled by their date/time instances despite hardware or software malfunction or corruption.

### OPERATION

The operation of the present system and process involves entry into a RAID storage array of a digital computer system, at a succession of date/time instances, a succession of records of electronic documents, some of which may have corresponding physical originals, assignment of attributes to the records in any data-type formats that characterize the documents, assignment of a succession of unique date/time identifiers to the succession of records in correspondence with the date/time instances of their entry, selection of a range of date/time instances that correspond to a range of the records of documents that are known to be uncorrupted, and selection of groups of electronic documents having logically related attributes within the range of the uncorrupted documents.

A relational database that may be advantageously used with the aforementioned system includes a structure of tables and forms having the following nomenclature and contents: CODE table and form containing records of Persons & Organizations; a FILE table and form containing records of File Numbers & Physical Locations; a CASE table and form containing combination records in the form cccccffffff, which correspond to a junction of key CODE and FILE entries; a PLAN table and form containing records of Events, Tasks, Dates; and a VIEW table and form containing records and views of Physical Documents including Things.

1-9. (canceled)

10. A method comprising:
producing a plurality of electronic documents corresponding to a plurality of physical documents;
assigning a first identifier corresponding to each of the plurality of electronic documents, wherein the first identifier is indicative of a date and time at which the corresponding electronic document was produced;
storing each of the plurality of electronic documents in a computer database at a location that depends upon the corresponding first identifier; and
accessing a particular stored electronic document in the computer database using the first identifier.

11. The method of claim 10,
wherein said storing the plurality of electronic documents in the computer database comprises generating a record for each of the plurality of electronic documents, wherein each record comprises a plurality of attributes for each of the plurality of electronic documents, wherein the plurality of attributes comprise the corresponding first identifier for each of the plurality of electronic documents.

12. The method of claim 11, wherein said accessing comprises accessing the plurality of records using the identifier to access the particular stored electronic document.

13. The method of claim 11,
wherein the plurality of documents comprise a plurality of physical media, wherein said producing said plurality of electronic documents includes creating a record that comprises attributes indicating a physical location of the corresponding physical media.

14. The method of claim 11, further comprising:
assigning one or more second identifiers to the plurality of attributes for a corresponding record for each of the plurality of the electronic documents, wherein each of the one or more second identifiers is indicative of attributes of the corresponding electronic document other than date and time.

15. The method of claim 14, wherein the one or more second identifiers is indicative of a physical location of a corresponding physical document in a physical storage system.

16. The method of claim 15, wherein the plurality of physical documents are stored using the first identifier as an indexing mechanism.

17. The method of claim 11, wherein the computer database comprises one or more tables, wherein the one or more tables comprise a combination of a plurality of records for the plurality of electronic documents facilitating access to the plurality of electronic documents.

18. The method of claim 17, wherein the one or more tables comprises one or more of:
a CODE table containing records of one or more persons or organizations;
a FILE table containing records of one or more of file numbers or physical locations of each of the plurality of physical documents;
a CASE table containing combination records which correspond to a junction of a CODE table and the FILE table entries;
a PLAN table containing records of one or more of events, tasks, or dates; or a DOC table containing one or more of records or views of one or more of the plurality of electronic documents.

19. The method of claim 10, further comprising:
storing the plurality of electronic documents in a redundant storage system.

20. The method of claim 10, wherein said producing a plurality of electronic documents comprises scanning or faxing the plurality of physical documents.

21. The method of claim 10, further comprising:
accessing the plurality of electronic documents using a graphical user interface, wherein the graphical user interface can be used to select one or more electronic documents.

22. The method of claim 21, wherein the selected one or more electronic documents correspond to a range of electronic documents that are known to be uncorrupted.

23. A system comprising:
a document acquisition sub-system configured to convert a plurality of physical documents into a plurality of electronic documents, wherein each of the plurality of electronic documents comprises a first identifier indicating a date and time of a conversion of a physical document into a corresponding electronic document;
a database server including a database program configured to manage the plurality of electronic documents;
a RAID disk array configured to store the plurality of electronic documents;
wherein the database program is configured to access a particular stored electronic document using using the first identifier.

24. The system of claim 23,
wherein the database server is configured to generate a record for each of the plurality of electronic documents, wherein each record comprises a plurality of attributes for each of the plurality of electronic documents, wherein the plurality of attributes comprise the corresponding first identifier for each of the plurality of electronic documents.

25. The system of claim 23, wherein the database server is further configured to access the plurality of records using the identifier to access the particular stored electronic document.
